(19) United States
(12) Patent Application Publication
(10) Pub. No.: US 2019/0210073 A1
(43) Pub. Date: Jul. 11, 2019

(54) METHOD AND DEVICE FOR CLEANING METAL WORKPIECES

(71) Applicant: ELWEMA Automotive GmbH, Ellwangen (DE)

(72) Inventors: Antonio ALVAREZ, Stolberg (DE); Dietmar SONNTAG, Simmerath (DE)

(21) Appl. No.: 16/096,770

(22) PCT Filed: Apr. 27, 2017
(86) PCT No.: PCT/EP2017/060140

§ 371 Date: Mar. 11, 2019

(30) Foreign Application Priority Data
Apr. 27, 2016 (DE) 10 2016 107 840.9

(51) Int. Cl. B08B 3/02; B08B 3/10; B08B 3/14; F26B 5/04; F26B 11/04

(52) U.S. Cl. CPC B08B 3/024; B08B 3/10; B08B 2230/01; F26B 5/04; F26B 11/049; B08B 3/14

(57) ABSTRACT

In conventional methods for cleaning the surface of workpieces in automatic production by means of vapor or hot water, the temperature of workpieces can undergo such a change that the dimensions exceed tolerances as a result of the thermal expansion, and subsequent mounting or processing is only possible after a thermal treatment step. Cleaning is performed by scanning a jet of vapor or hot water over the surface of the workpiece and carrying out this process at reduced pressure, so that the residues of condensed vapor or water that are present on the surface evaporate at least partially, and thereby extract from the workpiece heat that has been supplied by the vapor or the hot water. Preferably, the cleaned surface is at the same time dried.

### CROSS-REFERENCE TO RELATED APPLICATIONS

This application is a Section 371 of International Application No. PCT/EP2017/060140, filed Apr. 27, 2017, which was published in the German language on Nov. 2, 2017, under International Publication No. WO 2017/186888 A1, which claims priority under 35 U.S.C. § 119(b) to German Application No. 10 2016 107 840.9, filed Apr. 27, 2016, the disclosures of which are incorporated herein by reference in their entirety.

### TECHNICAL FIELD

The invention relates to a method and a device for cleaning metal workpieces by means of a jet of steam and/or hot water.

### BACKGROUND ART

Metal workpieces are often processed and finished on automatic production lines in mass production. These methods are very important in the automotive industry in particular. Machining methods are often used here in which lubricants are employed and chips and burrs are formed. Recently, so-called minimum quantity lubrication has come into widespread use, in which only small quantities, e.g. <100 (small quantity cooling lubrication, SQCL) or even <20 ml/h (minimum quantity lubrication, MQL), of the cooling lubricant are applied. The advantages of this method include the fact that only very small quantities of liquid waste are obtained and that the chips that are formed are not contaminated and are readily reusable. Before these workpieces are processed further or mounted in assemblies, contaminants such as residues of the cooling lubricant have to be removed. Numerous methods which use aqueous or non-aqueous solvents are known for this purpose, with aqueous solvents being preferred more recently since they are less expensive and cause fewer environmental problems.

The workpieces are typically dipped in the solvents and/or treated with a jet of the solvent, removing not only lubricant residues and chips but also unwanted burrs.

DE 44 10 550 C1 describes a method for drying workpieces that have undergone a cleaning and rinsing operation in a pressure-sealed chamber, wherein the parts in the chamber are initially heated by steam introduced under pressure, wherein the parts are initially rinsed by the condensed water that has formed. If the pressure is then reduced optionally to below atmospheric pressure, the condensed water residues on the surface of the parts evaporate, and the parts can then be removed from the chamber in a dry state. The parts are subject to severe temperature variations here, e.g. from over 100° C. to almost 0° C.

In industrial cleaning processes, the use of negative pressure for the purpose of drying cleaned workpieces in so-called “vacuum drying” is known. The drying in this case takes place in a separate process step following the actual cleaning.

DE 10 2007 027 944 A1 discloses a method and an apparatus for cleaning objects that are contaminated with oily or greasy processing residues, with the aid of a high-pressure vapor jet in a closed treatment chamber under a pressure that is lower than atmospheric pressure, wherein cleaning agents or abrasive agents are introduced into the high-pressure vapor jet. In this method too, the workpiece is subject to severe temperature variations.

It has been shown that it is disadvantageous if, after cleaning and optionally drying, the parts have a temperature that differs significantly from the environment in which the further processing or mounting is to take place. For example, a workpiece made of aluminum (coefficient of linear thermal expansion 23*10′) with a diameter of 100 mm becomes 23 μm larger when heated by 10 K. If it is to be installed in a drilled hole of appropriate size, the nature of the fit changes as a result of temperature compensation. In the event of further processing, on the other hand, there is a risk that too much material will be removed. The workpiece therefore has to be heat-treated before mounting, which takes a significant amount of time in the case of larger objects.

### BRIEF DESCRIPTION OF THE INVENTION

The object of the present invention is to provide a method by which metal workpieces can be cleaned and optionally dried, in particular after machining with minimum quantity lubrication, wherein the temperature of the workpiece remains within limits that allow further processing or mounting without previous thermal treatment. A further object consists in providing a device with which this method can be performed.

A method is disclosed for cleaning the surface of a metal workpiece by means of at least one jet of vapor and/or hot water impinging on the surface at a point of impingement. The point of impingement is moved relative to said surface in a scanning manner, and the surface contaminants are transported in the scanning direction. The method is performed in a closed container in a reduced pressure atmosphere, so that the residues of condensed vapor or water that are present on said surface behind said point of impingement in the scanning direction at least partially evaporate, thereby at least partially extracting from the workpiece the heat supplied by the jet.

In certain embodiments, a method is characterized in that after the end of the cleaning or cleaning and drying the temperature of the workpiece differs by no more than 2 K from the temperature before the cleaning.

Surprisingly, it has been found that, when cleaning with a jet of vapor and/or hot water, in particular steam, the contaminants that are present can be stripped off the workpiece if this jet is scanned relative to the surface of the workpiece if, at the same time, a negative pressure is established relative to the external atmospheric pressure. As a result of the negative pressure, the water remaining on the surface is evaporated, at least partially extracting from the point being processed the heat that has been supplied by the vapor or the hot water, so that this point returns to the temperature prevailing prior to processing before the heat can spread in the workpiece. At the same time, the contaminants are either transported over the surface in the scanning direction with any water that has condensed, dropping off into a sump at the end of the scan path, or removed from the surface by spraying. At the point of impingement, only pure water remains—possibly from the condensation of the vapor—which can evaporate without leaving any residues because of the negative pressure.

The hot water preferably has a temperature of 70 to 95° C. before it passes through the nozzle. If vapor is used, this preferably has a pressure of 0.2 to 1 MPa, particularly preferably 0.2 to 0.4 MPa, in particular 0.3 MPa (absolute), and a temperature of between 120 and 200° C., particularly preferably 135 to 160° C. and in particular 140° C., before it passes through the nozzle.

The use of steam, in particular superheated steam (unsaturated steam or dry steam) or saturated steam, is preferred. Water without additives is preferably used for vapor generation.

An electrode steam generator is preferably employed to generate the vapor. In this case it is preferred to use not demineralized water but water with adequate conductivity, in particular with a mineral content, e.g. tap water or well water. The water here can in particular be circulated.

With regard to the relative movement of the jet, “scan” means in this context that the point of impingement, i.e. the point at which the jet of vapor or hot water impinges on the surface of the workpiece and contaminants from the surface are taken up in the water or condensed water, is guided along a continuous path in the direction from one end of the workpiece to the other end. This scan path can have a continuous route from one end to the other or can consist of multiple sections. If multiple nozzles for generating jets are present, multiple scan paths assigned to the individual nozzles can be present or some or all of the nozzles can each contribute only a section to a scan path.

In the simplest case, sufficient nozzles can be arranged around the workpiece that the corresponding scan points overlap and the entire surface of the workpiece can be cleaned and dried by a simple linear movement.

The reduced pressure in the closed container is preferably between 850 and 20 hPa absolute, particularly preferably between 100 and 300 hPa absolute.

In a preferred version, the method according to the invention can be performed such that the residues of water left on the workpiece surface evaporate completely, i.e. that a drying of the workpiece surface takes place in the same process step as the cleaning. Since the workpiece is then dry and is at an appropriate temperature, it can be processed further or mounted immediately.

Preferably, the scanning of the surface of the workpiece is carried out such that the scan point moves along a helical path, which is obtained by superimposing a circular movement and a linear movement. In this case, the transport of the contaminants takes place continuously in a direction opposite to that of the linear movement, towards the end of the workpiece. For this type of embodiment, one nozzle is sufficient. The linear movement can be continuous. However, it can also be performed stepwise e.g. after every one or more complete circular movements.

The scanning can advantageously take place by moving the workpiece, the nozzle or both parts. The circular movement can be achieved by simple means, e.g. by turning the workpiece around an axis which coincides with the directional axis of the linear movement. However, it is also possible to move only the nozzle on a closed path around the workpiece. In this case it can be expedient to return the nozzle back to the starting point after it has completed a circular path in order to facilitate the supply of vapor or hot water to the nozzle. During the return, the linear movement can be stopped.

Also preferred is an embodiment in which the workpiece is guided in a linear manner past an arrangement with at least one nozzle rotating around an axis parallel to its own axis.

In a preferred embodiment, multiple nozzles are present, which are arranged in the direction of the linear movement and/or in a plane around the workpiece, preferably with the same angular separations in each case. In the latter case it may be advantageous if the nozzles describe not complete circular movements but only arcs, the length of which can correspond e.g. to the angular separation or a multiple thereof After the movement along such an arc they are returned, resulting in an oscillating movement. This facilitates the supply of vapor or hot water to the nozzles. Instead or in addition, the workpiece can also be moved about an axis in an oscillating manner. This axis is preferably the direction of the linear movement.

Furthermore, it is advantageous to perform the movement such that its direction is vertical, i.e. for example to move the workpiece vertically from bottom to top and/or to move the nozzles from top to bottom. In this case, gravity supports the transport of the contaminants and of the cleaning water to the lower region of the container and towards the sump.

This transport is also promoted in a further advantageous embodiment if the nozzles are arranged in relation to the workpiece such that the jet of vapor or hot water forms an angle of between e.g. 90 and 135°, preferably between 90 and 105°, with the direction of the linear movement, i.e. if it is directed obliquely downwards. In order to be able to clean the entire surface of more complicated workpieces with blind holes, undercuts and the like, additional nozzles can preferably be affixed, in which the jet of vapor or hot water is directed perpendicularly to the linear movement or at an angle of e.g. 45 to 90°, preferably 75 to 90°, i.e. obliquely upwards.

In a further preferred embodiment, one or more nozzles are located on a nozzle carrier, e.g. a cross-shaped or disc-shaped nozzle carrier, which is further preferably configured in a rotatable manner. The jet directions of the one or more nozzles in this case can form an angle of 0 to 45°, preferably 0 to 15°, with a line perpendicular to the surface to be treated, i.e. they can be oriented such that they are perpendicular or oblique to this surface. By rotating the nozzle carrier, the direction of the oblique position optionally changes in this way. In particular, nozzles with different directions, within the above limits, can also be arranged on one nozzle carrier. This leads to a further improved cleaning action on complex parts (with irregular surfaces). The invention is suitable in particular for machined metal workpieces.

The speed of a rotating nozzle carrier is preferably over 750 min⁻¹, particularly preferably between 1250 and 1750 min⁻¹, in particular 1500 min⁻¹.

Where the nozzles are arranged on a nozzle carrier, a certain region can be left free around the axis of rotation. This region can be provided with a rotor blade structure, optionally with openings to the rear, in which case it generates a suction effect away from the workpiece as a result of its rotation, causing condensate and steam to be transported away and promoting drying.

The water running downwards off the workpiece and the water splashes running down the inner wall of the container collect in a sump at the bottom of the container from where they can be removed by suction or drained off.

The method according to the invention can be supplemented by applying an aqueous solution of a cleaning agent on to the surface of the workpiece, preferably by spraying, before it is introduced into the closed container for cleaning and optionally drying, as described e.g. in the pending patent application DE 10 2014 101 123 A1. In this case, a cleaner concentrate with a content of at least 0.5 wt. % of a nonionic or anionic surfactant is applied on to the workpiece. The nonionic surfactant can be an alkoxylate of a fatty alcohol with 6 to 22 carbon atoms in the alkyl residue. The anionic surfactant can be a sulfate, sulfonate or a carboxylic acid with an aliphatic, aromatic or aliphatic-aromatic hydrocarbon residue. The application of the cleaning solution can also take place by briefly dipping in a bath.

In a particularly preferred embodiment, the surface temperature of the workpiece behind the point of impingement, viewed in the direction of movement thereof, is measured in a contactless manner. Negative pressure and mass flow of the vapor or hot water are controlled accordingly such that the desired surface temperature, e.g. the temperature in the workpiece before the cleaning or the temperature prevailing during the further processing or mounting, is obtained. This can prevent any change in the workpiece temperature, and thus the dimensions of the workpiece, as a result of applying the method according to the invention.

The method is preferably performed such that, after the end of the cleaning and optional drying, the temperature of the workpiece differs by no more than 2 K from the temperature before the cleaning. However, it is of course also possible to perform the method such that a preset temperature change is obtained.

The invention also comprises a device for performing the method described above, comprising
a treatment chamber having an opening, which allows the passage of the workpiece to be cleaned and which can be pressure-sealed,
a holder for said workpiece, with which it can be held and moved within said treatment chamber,
at least one nozzle arrangement each having one or more nozzles, wherein holder and nozzle arrangement(s) can be moved relative to each other,
a device for generating negative pressure connected to the interior of said treatment chamber,
an assembly for generating hot water or steam under increased pressure, which is connected to said nozzles, and
means for adjusting the temperature of the hot water or steam and/or for adjusting the mass flow flowing through said nozzles.

These means for adjusting the mass flow can adjust, for example, either the pressure of the water or vapor or the flow resistance of the lines and nozzles, or both. The flow resistance can be adjusted e.g. by means of throttle valves, variable apertures or the like.

The device according to the invention preferably comprises a nozzle arrangement in which multiple nozzles are arranged on at least one closed curve surrounding the workpiece. This closed curve can be e.g. a circle in a plane or a closed zigzag line. Closed curves are also possible which are specially adapted to the shape of the workpiece. In this way, the workpiece can be completely cleaned with a simple linear movement, optionally combined with an optionally oscillating rotation.

Alternatively or in addition, the at least one nozzle arrangement of the device according to the invention can comprise at least one nozzle that can rotate around an axis parallel to and/or at a distance from its own axis. In this case, it is also possible for multiple nozzles to be mounted on a rotating head. The scan path generated by such a nozzle arrangement then results from superimposing a circular movement and the linear movement of the workpiece and/or nozzle arrangement. The nozzles can also be oriented at an angle of e.g. 0 to 45°, preferably 0 to 15°, to the axis of rotation.

In a preferred embodiment, the nozzles are affixed to a multi-arm nozzle carrier such that a central region around the axis of rotation remains free from nozzles. The nozzle carrier can be provided with a rotor blade structure, optionally with openings to the rear, so that a suction effect from the nozzle side to the rear is obtained during rotation.

In a further embodiment, the holder for the workpiece is utilized simultaneously as a closure for the opening of the treatment chamber. This can readily be achieved if the holder can be moved into and out of the treatment chamber.

The device preferably further comprises means with which the surface temperature of the workpiece can be measured at at least one specific point. In order to avoid disrupting the cleaning and optional drying operation, contactless measuring means are preferred. These can be e.g. infrared thermometers, in which the region of the workpiece to be measured is imaged on a suitable detector by an infrared lens, wherein this measuring line can also be adjusted to the emission properties of the workpiece surface.

If the temperature of the workpiece surface behind the point of impingement can be measured, it is possible to adjust the vapor or hot water stream and the negative pressure manually such that the desired surface temperature is obtained. Preferably, however, the device according to the invention comprises a closed-loop control system, which automatically regulates either the vapor or hot water stream or the negative pressure, or both, based on the measured surface temperature and its deviation from a set target value.

Since the interior wall of the container can also be contaminated by splashing of the cleaning water, which contains the removed contaminants, it is advantageously coated with a dirt- and water-repellent substance, e.g. polytetrafluoroethylene or silicone resin.

The method according to the invention can be integrated into automatic production processes, wherein it can take place between machining or forming and mounting. Since it allows cleaning and drying in one operation, the entire process is simplified. In particular, it is suitable for the automated cleaning and optional drying of parts in the automotive industry, in particular components of internal combustion engines, e.g. engine blocks, cylinder heads, crankcases, gearboxes and the like.

The method according to the invention can be inserted in the takt of appropriate production lines without any problems. For example, the usual takt time of the method when producing cylinder heads or engine blocks for car engines can be broken down into three approximately equal parts: the actual cleaning and drying operation, the introduction of air and opening of the vacuum chamber, and the changeover of the workpiece with sealing of the chamber and production of the negative pressure, e.g. approx. 10 s each for a takt time of approx. 30 s in total. The method is suitable for workpieces made of a variety of materials, such as iron, grey cast iron, steel, brass, bronze, zinc and alloys thereof. In particular, it is advantageous for materials made of lightweight metals, which typically have higher coefficients of thermal expansion. Examples are aluminum, aluminum alloys with silicon, magnesium, copper, in particular aluminum casting alloys, magnesium, magnesium alloys, titanium and alloys thereof.

As a result of the method according to the invention, the quantity of contaminated waste water is markedly reduced compared to the prior art, resulting in reduced costs.

The energy consumption in the method according to the invention can be kept comparable to or even lower than that in conventional cleaning using compressed air. However, the surface is completely freed from moisture, lubricant residues and other contaminants, which is not possible with compressed air.

### BRIEF DESCRIPTION OF THE FIGURES

The invention is explained in more detail below with reference to the attached drawings by way of example and without limiting the scope of protection.

FIG. 1 shows a schematic longitudinal section through a device according to the invention according to a first embodiment.

FIG. 2 shows a schematic side view of the workpiece with the scan path of the device according to FIG. 1 drawn in.

FIG. 3 shows a schematic cross-section through a device according to the invention according to a second embodiment.

FIG. 4 shows a schematic side view of the workpiece with scan paths of the device according to FIG. 3 drawn in;

FIG. 5 shows an alternative exemplary embodiment with recirculation of the cleaning fluid as a simplified flow diagram.

### DETAILED DESCRIPTION WITH REFERENCE TO THE FIGURES

In FIG. 1 a device for performing the method according to the invention is illustrated in a schematic longitudinal section. The device comprises a container 1, which is open at the top and can be sealed in a vacuum-tight manner by a lid 2 with the participation of a gasket 3. The container 1 continues downwards via a connecting tube 13 into a sump container 10. In the container 1, a workpiece 4 to be cleaned is accommodated and is held by a holder. For reasons of clarity, this holder and the feed-through through the container edge needed for performing the optional linear and rotating movement of the workpiece 4 are not shown here, but can be readily added by the person skilled in the art. This holder with the workpiece 4 can perform a rotating movement around an axis 5, as described by the closed arrow 7, at the same time as a linear movement in the direction of the arrow 6, which lies in the axis 5 here. The axis of rotation 5 of the workpiece is oriented in a vertical direction here.

In the sump container 10, during operation of the device, a sump 11 can form as a result of the runoff of water that may be contaminated, which can be drained off or removed by suction via a sump valve 12.

In the container 1, a negative pressure can be generated if the pump 20 sucks air out of the interior of the container 1 via the vacuum line 21. The vacuum line 21 can be attached to the sump container 10 or directly to the container 1.

In the wall of the container 1, a nozzle 27 is installed, which is connected via a line 26 to a generator unit for vapor or hot water. This unit is controllable in terms of the pressure and temperature of the vapor or hot water. The mass flow of the respective medium can also be controlled thereby. The nozzle 27 forms an obtuse angle a of, in this case, e.g. about 110° with the vertical or with the axis 5 of the workpiece. The jet 28 of the medium (vapor or hot water) impinges at virtually the same angle on the surface of the workpiece 4 at a point of impingement.

In the wall of the container 1, furthermore, an infrared temperature sensor 31 is installed, in which the measurement point 36 on the surface of the workpiece 4 is imaged by an infrared lens on a detector, which emits a signal corresponding to the surface temperature via a measuring line 32. To measure the negative pressure, moreover, a vacuum sensor 30 is installed in the wall of the container 1, which emits a signal corresponding to the negative pressure in the container 1 via a measuring line 33.

A controller unit 35 receives signals via the measuring lines 32 and 33 and, via the control lines 40 and 41, controls the mass flow of the respective medium emitted by the generation unit 25 such that the temperature measured by the temperature sensor 31 via the measuring line 32 takes a preset target value.

For the cleaning and drying of a workpiece 4, the container 1 is first opened by removing the lid 2 and the workpiece 4 is brought into the operating position, where it is held in a rotatable and displaceable manner by the holder (not shown). It is initially located in the lower starting position shown with dotted lines. The container 1 is sealed in an airtight manner with the aid of the gasket 3 by putting on the lid 2. The generator unit 25 and the vacuum pump 20 are then switched on via the controller unit 35 and the linear and rotating movement of the workpiece 4 is started. First the end surface of the workpiece 4 is cleaned by the vapor or hot water jet 28 and then the side surface. After the temperature at the measurement point 36, moving across the surface, has been measured by the temperature sensor 31, mass flow and negative pressure are regulated by the controller unit 35 from the initially preset starting values such that the preset target temperature is obtained at the measurement point 36.

If vapor is used for the cleaning, contaminants on the surface of the workpiece 4 are removed from the surface partly mechanically by the transferred momentum of the vapor jet and also by dispersion in the water resulting from condensation and are entrained by the water. A hot water jet acts in a similar fashion. Some of this water runs along and off the surface of the workpiece 4 and some of it is splashed and lands on the interior wall of the container 1, where it can also run off downwards. Finally, some of the water also remains on the surface, wetting it, and evaporates, extracting heat from the surface. The run-off water passes via the connection 13 into the sump container 10 and forms the sump 11, which can be drained off through the valve 12, e.g. while the container 1 is open for workpiece changeover, or can be pumped off, e.g. continuously.

FIG. 2 illustrates the progress of the cleaning according to the exemplary embodiment of the invention shown in FIG. 1. As a result of the linear movement of the workpiece 4, the vapor jet or hot water jet first impinges on the side surface of the workpiece 4 at the point of impingement 51 and then migrates along the hypothetical scan path 50 around the workpiece 4 in a helical manner until it has scanned the entire surface. The linear and rotating movements are coordinated such that the workpiece 4 is moved in a linear manner by one stroke h during one rotation. The point of impingement 51, 52 is not punctiform but, because of the oblique position of the nozzle 27, approximately elliptical with the larger axis directed in the vertical direction. As shown by the successively attained points of impingement 52, a certain overlap occurs in the points of impingement in adjacent branches of the scan path 50. This means that the cleaning process is repeated and the cleaning effect is improved. The extent of the overlap can be modified by adjusting the stroke h.

FIG. 3 shows a diagram of a second embodiment of the device according to the invention in cross-section, wherein only the modified parts are illustrated. In this embodiment, four nozzles 68 are arranged in a plane on the circumference of the container 1 at equal angular separations from each other. These act on the surface of the workpiece 4 simultaneously.

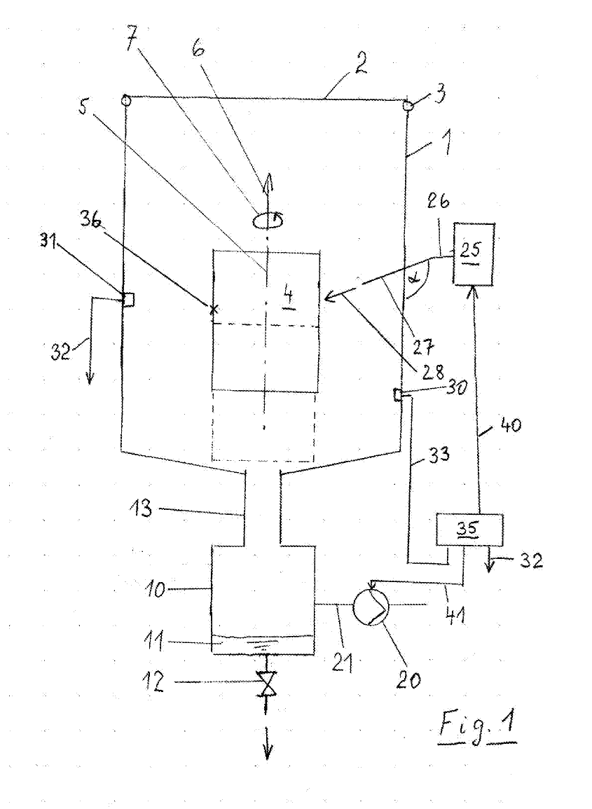

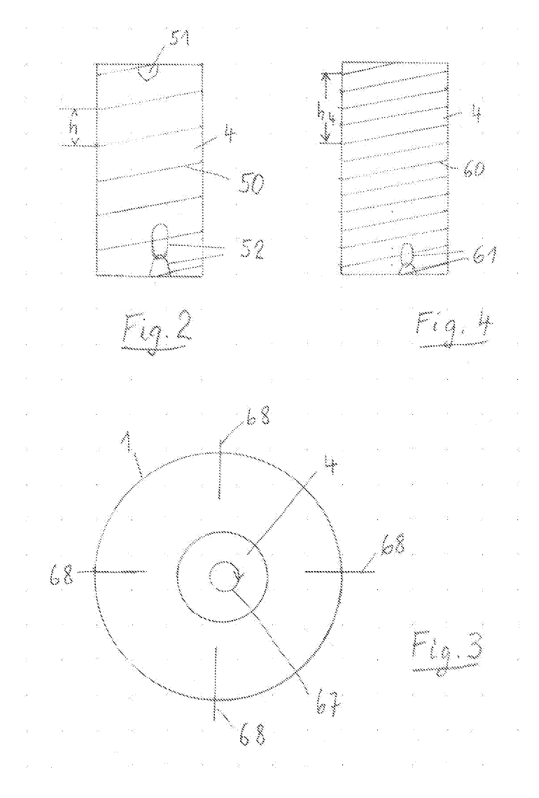

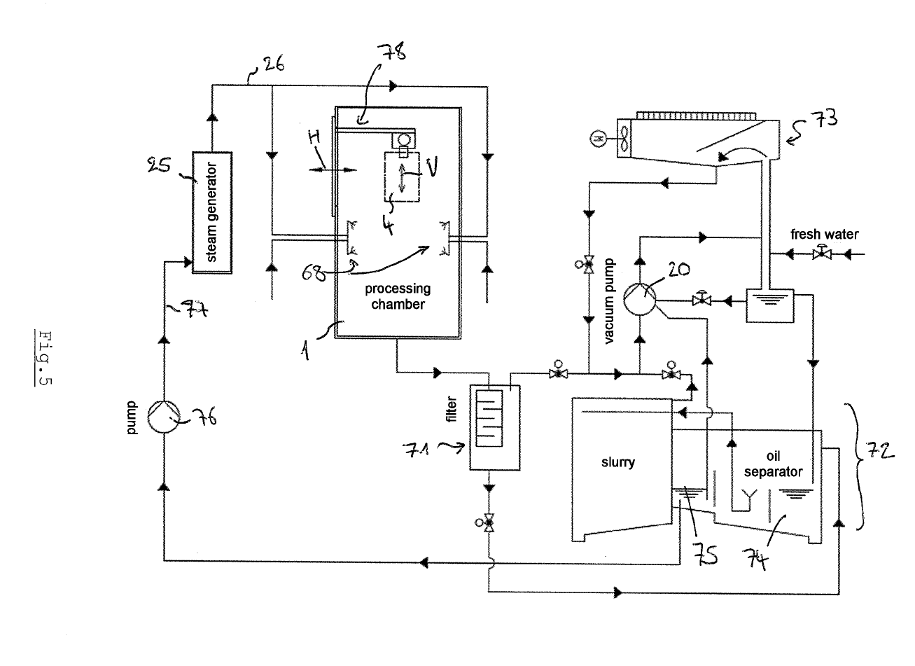

FIG. 4 illustrates the route of the four scan paths 60 generated by the nozzles 68 of the embodiment shown in FIG. 3 on the surface of the workpiece 4. In this case, the workpiece 4 is moved in a linear manner by the stroke h in 1 turn. Again, the points of impingement 61 of the adjacent scan paths 60 overlap and the extent of the overlap can be adapted by adjusting the stroke as required.

To demonstrate the cleaning and drying effect, a cylinder head for a car engine was treated according to the invention. A commercial adhesive film was placed on to a smooth, cleaned and dried surface where it adhered firmly over the whole area. In a comparative test with a cylinder head that had been cleaned in a conventional manner with compressed air, the adhesive film could not be attached even to the same smooth area.

In FIG. 5, parts with identical construction or function are referred to using the same reference signs as in FIGS. 1-4.

This exemplary embodiment differs primarily in the development of the recirculation circuit by means of which cleaning fluid is recovered from the treatment chamber 1. The vapor clouds generated by the negative pressure and the temperature are sucked out of the treatment chamber 1 by the vacuum pump 20 via a first filter unit 71 and then fed to a downstream second filter and separator stage 72, which comprises an oil separator 74. The outlet of the filter unit 71 opens into the oil separator 74. On the outlet side, the vacuum pump 20 is connected to a condensation unit 73, the return of which likewise opens into the oil separator 74. From a clean tank 75 in the second filter and separator stage 72, via a water pump 76 in a feed line 77, the vapor generator 25 is fed. As a result of the output pressure of the vapor generator 25 and the suction action of the vacuum pump 20, it is ensured that vapor is injected with high dynamic jet pressure. In addition, residual heat from the recovered cleaning fluid is utilized by the circuit according to FIG. 5, so that additional energy savings are achieved. Fresh water is only supplied as necessary based on the losses in the second filter and separator stage 72.

FIG. 5 also illustrates schematically a holder 78 for the workpiece 4 which can be moved automatically into and out of the treatment chamber on two axes H, V. The holder 78 simultaneously forms a pressure-resistant closure for the opening of the treatment chamber 1 in the operating position.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1-27. (canceled)

28. A method for cleaning a surface of a metal workpiece by means of at least one jet of vapor and/or hot water impinging on the surface at a point of impingement.
wherein the point of impingement is moved relative to the surface in a scanning manner in a scanning direction and surface contaminants are transported in the scanning direction; and
wherein the method is performed in a closed container in a reduced pressure atmosphere, so that residues of condensed vapor or water that are present on the surface behind the point of impingement in the scanning direction at least partially evaporate, thereby at least partially extracting from the workpiece the heat supplied by the jet.

29. The method according to claim 28, wherein the jet is a jet of steam.

30. The method according to claim 28, wherein the surface of the workpiece is dried behind the point of impingement in the same process step.

31. The method according to claim 28, wherein, after the end of the cleaning or cleaning and drying, a temperature of the workpiece differs by no more than 5 K from a temperature of the workpiece before the start of cleaning.

32. The method according to claim 28, wherein the scanning is effected by moving the workpiece and/or at least one nozzle.

33. The method according to claim 28, wherein the scanning takes place over a scan path, which results from superimposing a circular movement and a linear movement.

34. The method according to claim 28, wherein several nozzles are present.

35. The method according to claim 34, wherein the nozzles are arranged in one or more planes around the workpiece.

36. The method according to claim 33, wherein the workpiece is guided in a linear manner past an arrangement with at least one nozzle rotating around an axis parallel to and at a distance from its own axis.

37. The method according to claim 32, wherein the nozzles and/or the workpiece are moved in an oscillating manner.

38. The method according to claim 33, wherein the direction of the linear movement is vertical.

39. The method according to claim 38, wherein the jet forms an angle of between 90 and 135° with the direction of the linear movement.

40. The method according to claim 28, wherein water run-off or water splashes are collected in a sump at the bottom of the container and pumped off.

41. The method according to claim 31, wherein before the cleaning or the cleaning and drying, an aqueous solution of a cleaning agent is applied to the workpiece, preferably by spraying.

42. The method according to claim 41, wherein a surface temperature of the workpiece behind the point of impingement, viewed in scanning direction, is measured in a contactless manner, and the reduced pressure, and a mass flow of said vapor or hot water, are controlled accordingly.

43. The method according to claim 42, wherein after the end of the cleaning or cleaning and drying the temperature of the workpiece differs by no more than 2 K from the temperature before the cleaning.

44. A device for cleaning a surface of a workpiece comprising;
a treatment chamber having an opening, which allows the passage of the workpiece to be cleaned and which can be pressure-sealed;
a holder for the workpiece, with which the workpiece can be held and moved within the treatment chamber;
at least one nozzle arrangement each having one or more nozzles, wherein the holder and the at least one nozzle arrangement can be moved relative to each other;
a negative pressure generator of a negative pressure connected to an interior of the treatment chamber;
an assembly for generating hot water or steam under increased pressure, the assembly being connected to the nozzles, and
means for adjusting the temperature of the hot water or steam and/or means for adjusting a mass flow flowing through the nozzles.

45. The device according to claim 44, wherein the negative pressure generator comprises a vacuum pump and the assembly comprises a vapor generator.

46. The device according to claim 44, further comprising a filter unit through which the negative pressure generator vacuum pump sucks steam with contaminant residues out of the treatment chamber.

47. The device according to claim 46, wherein a further filter stage and/or a separator stage is attached to the filter unit from which recovered cleaning fluid is fed to the assembly for generating hot water or steam in a closed circuit.

48. The device according to claim 44, wherein the means for adjusting the mass flow adjusts the pressure of the water or vapor and/or the flow resistance of lines carrying the water and/or vapor.

49. The device according to claim 44, wherein the nozzle arrangement comprises at least one nozzle rotating around an axis parallel to and/or at a distance from its own axis.

50. The device according to claim 44, wherein the nozzles of a nozzle arrangement are arranged on a nozzle carrier which is rotatable around an axis of rotation directed towards the workpiece and wherein each of the nozzles forms an angle of between 0 and 45°, preferably 0 to 15°, with the axis of rotation, wherein this angle can be the same or different for all the nozzles of this nozzle arrangement.

51. The device according to claim 50, wherein the nozzle carrier has a rotor blade structure.

52. The device according to claim 44, further comprising means for measuring a surface temperature of the workpiece.

53. The device according to claim 52, further comprising a closed-loop control system for the negative pressure and the mass flow flowing through the nozzles based on the measured surface temperature.

54. The device according to claim 44, wherein the holder can be moved into and out of the treatment chamber and comprises a pressure-resistant closure for the opening of the treatment chamber.
